(19) United States
(12) Patent Application Publication
(10) Pub. No.: US 2019/0044457 A1
(43) Pub. Date: Feb. 7, 2019

(54) ELECTRICAL POWER GENERATOR

(71) Applicants: HENRIK HENRIKOVYCH SHUMINSKYI, Kakhovka (UA); OLEKSANDR IVANOVYCH HETMAN, Kakhovka (UA)

(72) Inventors: HENRIK HENRIKOVYCH SHUMINSKYI, Kakhovka (UA); OLEKSANDR IVANOVYCH HETMAN, Kakhovka (UA)

(21) Appl. No.: 16/077,393

(22) PCT Filed: Apr. 11, 2017
(86) PCT No.: PCT/UA2017/000038

§ 371 Date: Aug. 10, 2018

(30) Foreign Application Priority Data
Apr. 18, 2016 (UA) A 2016 04279

(51) Int. Cl. H02N 1/08; C01G 23/00

(52) U.S. Cl. CPC H02N 1/08; H01G 7/02; C01G 23/006

(57) ABSTRACT

Electrical power generator comprises a case (1) with a package of conductive plates of both signs including at least one unit cell, which consists of one layer of a ferroelectric material (3) and two dissimilar conductive plates which are placed in the following order: a conductive plate (2)—a ferroelectric material (3)—a conductive plate different from the first one (2). All the layers in the package are tightly fit to each other and the conductive plates (2) are made of dissimilar conductors with different concentration of free electrons. Ferroelectric semiconductors that are used as the ferroelectric material can be chosen from the list of sodium nitrite, semiconductor ceramics based on barium titanite, lithium niobate, potassium niobate, lead titanite, etc.

The invention is related to electrical engineering and can be used to generate electricity. Along with widely used traditional dynamic electrical power generators there exist less widespread static devices not containing mobile details where energy of chemical reactions, thermal energy, energy of a magnetic field, etc. is used.

There is a device for generating electrical power using internal energy of active dielectric materials—ferroelectrics and electrets (see the invention patent UA N284117, IPC (2006) H01M 6/00; H01G 4/00 published on 10 Sep. 2008).

This device for generating electrical power is compose of a case with packages of plates of both signs separated by a layer of ferroelectric material and equipped with a charge plate, separated from the rest by a ferroelectric layer, wherein the charge plate is made of bipolar electret, such as polytetrafluoroethylene, polycarbonate, calcium titanate, glass, etc. and the stabilized single crystal ferroelectric is used as a ferroelectric material, such as barium titanate, polyvinylidene fluoride, triglycine sulfate, potassium sodium tartrate, potassium dihydrogen phosphate, lithium niobate, ammonium ftorberilat and others, herewith the package of plates includes at least one elementary cell which consists of one electret, two plates of a ferroelectric material and two metal plates, at the same time all layers bear against each other and are arranged in the following sequence: a metal plate-a ferroelectric material-an electret-a ferroelectric material-a metal plate, and in case of presence in a package of more than one elementary cell they alternate in such a way that each subsequent elementary cell is arranged adjoining to the previous one by the similar charges of conduction part.

The ordered polarization of spontaneously polarized ferroelectric material is necessary for successful operation of the said device. Such polarization happens in the device under the influence of the constant electromagnetic field which is created by charging plates that are represented by electrets.

The main disadvantages of the mentioned device is short life expectancy of electrets, their low stability in the process of operation, as well as the complexity of manufacturing electrets and, naturally, their high cost.

The static generator of electric energy is known (see the patent for the invention of UA No. 85360, IPC (2006) H01G 4/12; H01G 4/008; H01G 4/018, published on Jan. 12, 2009) in which application of electrets is excluded, and ordering of polarization of spontaneously polarized ferroelectric material is carried out by means of the constant electromagnetic field created by the metal plates made of diverse conductors with a considerable difference of concentration of free electrons.

Static generator of electrical energy, including a case with a package of metal plates of both signs separated by a layer of a stabilized single crystal ferroelectric, and in the package all the layers are in close contact with each other, and the metal plates are made of dissimilar conductors with significant difference of the free electrons concentration i.e. of two different metals, for example, antimony-bismuth, iron-nickel, titanium-aluminum, and various alloys, such as chromel-alumel, chromel-Copel, or a metal-alloy combination, such as iron-Copel, antimony-alumel, chromel-bismuth, herewith a package of plates includes at least one elementary cell which consists of one layer of a ferroelectric material and two dissimilar conduction plates which are placed in the following order: a conduction plate-a ferroelectric material-a conduction plate different from the first one, and if the package contains more than one unit cell then they are connected to the a source of electrical energy in series or in parallel, or in combination—some unit cells are connected in series, and some are connected in parallel.

The disadvantage of this static electricity generator is small specific electric power due to a high internal electrical resistance of the unit cells. High internal resistance is caused by the use of a ferroelectric material, which by their nature are pronounced insulators with specific electrical resistance up to 1016 ohms·cm.

The said static generator is selected as prototype. The prototype and the claimed power generator have the following common features:
a case with a package of conduction plates of both signs that are separated by a layer of stabilized single crystal ferroelectric, wherein all layers in the package bear tightly against each other;
the package of plates includes at least one unit cell made layer-by-layer of a ferroelectric material and two metal plates made of dissimilar conductors with considerable difference of the concentration of free electrons, arranged in the following order: a conduction plate-a ferroelectric material-a conduction plate different from the first one;
unit cells are connected to the a source of electrical energy in series or in parallel, or in combination—some unit cells are connected in series, and some are connected in parallel.

It is known that there are ferroelectric materials possessing semiconductor properties as well, the so-called ferroelectrics—semiconductors occupying by the value of specific electrical resistance (10−2-107 Ohm·cm) intermediate position between conductors and insulators. For example, sodium nitrite (NaNO2), semiconductor ceramic materials based on lithium niobate, potassium niobate, lead titanate, barium titanate, and many others. (see V. M. Fridkin Ferroelectric semiconductors.—M.: Nauka, 1976.-408 p. V. V. Ivanov, A. A. Bogomolov, Ferroelectric semiconductors. Kalinin. Kalinin University Press, 1978. 96 p.)

In particular, a ferroelectric material barium titanate BaTiO3 is a dielectric with a specific electric resistance more than 1012 Ohm·cm, however it is possible to turn it into a ferroelectric semiconductor with a specific resistance of 10−103 Ohm·cm by means of forced recovery (see Patent RU 2162457, IPC (7) C04B35/468, C04B35/64, published on 27 Jan. 2001) or by controlling its valence (see Solid-state chemistry and modern micro- and nanotechnology VI International Conference. Kislovodsk Stavropol: NCSTU, 2006. 510 p. the sol-gel method for producing semiconductor barium titanate doped with lanthanum oxide Ba1-XLaXTiO3 and tungsten oxide BaTi1-XWX03 (x=0.001, 0.002). G. G. Emello, T. A. Shichkova).

For obtaining semiconductor ceramics based on barium titanate it is doped. Titanium Ti4+ ions are replaced by ions W6+Sb5+, Nb5+, Ta5+, etc. barium ions Ba2+ are replaced by Mn4+, La3+, Nd3+, Y3+, Gd3+, and others. The concentration of the doping elements is typically less than 0.3 atomic percents.

The basic purpose of the invention is to produce electrical power by means of utilizing the internal energy of the substance used.

The problem is solved in the electrical power generator, made up of a case with a package of conduction plates of both signs that are separated by a layer of stabilized single crystal ferroelectric, wherein all layers in the package bear tightly against each other, wherein the package of plates includes at least one unit cell made layer-by-layer of a ferroelectric material and two metal plates made of dissimilar conductors with considerable difference of the concentration of free electrons, arranged in the following order: a conduction plate-a ferroelectric material-a conduction plate different from the first one and unit cells are connected to the a source of electrical energy in series or in parallel, or in combination—some unit cells are connected in series, and some are connected in parallel, by means of the fact that stabilized single crystals of ferroelectric materials are replaced by stabilized single crystals of ferroelectric semiconductors, such as sodium nitrite, semiconductor ceramics based on barium titanate, lithium niobate, potassium niobate, lead titanate, etc. which reduce the internal electrical resistance of the unit cell and increase its specific electric power when it is connected to the electrical power source.

The new feature in the claimed device is the replacement of stabilized single crystals of ferroelectric materials by stabilized single crystals of ferroelectric semiconductors, such as sodium nitrite, semiconductor ceramics based on barium titanate, lithium niobate, potassium niobate, lead titanate, etc., which reduce the internal electrical resistance of the unit cell and increase its specific electric power when it is connected to the electrical power source.

The cause and effect relationship between the set of existing differences, that are claimed, and achievable technical result is as follows:
The use of ferroelectric semiconductors with electrical resistance of less than 107 ohms·cm as an active unit cell element instead of ferroelectric materials that are pronounced dielectrics with specific electric resistance up to 1016 ohms·cm allows to reduce the internal electrical resistance of the unit cell and to get larger specific electrical currents at the same pairs of the current collectors of the unit cell.

Increase in specific electric currents at a constant potential difference leads to the natural growth of specific electric power of a unit cell more than twofold in relation to a prototype.
The increase in the specific electric power of a unit cell allows to extend the possibility of practical use of the claimed generator, both technically and economically.

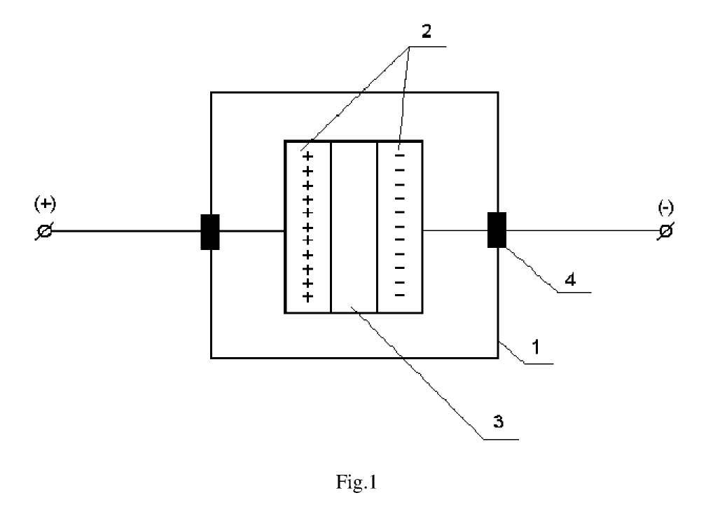

The electrical power generator consisting of at least one unit cell is shown on FIG. 1. This generator consists of a case 1 inside of which a pair of conductors 2 is placed made of dissimilar conductors with different concentrations of free electrons, between them, there is a ferroelectric-semiconductor 3, through the insulators 4 conductors 2 are connected to the electrical power source.

As examples of ferroelectric semiconductors used for manufacturing the said electrical power generator's elements the following semiconductor ceramics based on barium titanate are given:
barium titanate, doped with niobium (Nb) with atomic concentration of 0.220% and specific resistance of 6470 Ohm·cm;
barium titanate, doped with lanthanum (La) with concentration of 0.125 atomic % and specific resistance of 883,500 Ohms·cm.

Reference sample by prototype is made using barium titanate with specific resistance of 2710000000 Ohm·cm.

Iron-nickel is used as a pair of dissimilar conductors. Electrical power generator consists of at least one unit cell. The unit cell is manufactured by successive vacuum deposition on the anti-adhesive base coat with the surface of 1 dm².

Conductor layers are formed with thickness of 9-10 micron, a layer of a ferroelectric-semiconductor is formed with thickness of less than 1 micron providing a continuous pore-free uniform coating.

### EXAMPLE 1

Making the unit cell reference sample by the prototype of the barium titanate. A pattern having a surface area of 1 dm² is placed on the polished polytetrafluoroethylene base coat treated with polymethyl and a layer of iron with thickness of 9-10 microns is sprayed. The pattern is removed and another layer of barium titanate is sprayed, providing a continuous uniform non-porous coating with a thickness of up to 1 micron.

Then the pattern is placed back and a nickel layer with thickness of 9-10 microns is sprayed. The pattern is removed and a finish element is separated from base coat with a vacuum cup. Using diethyl ether polymethylsiloxane traces are removed from the surface layer of iron and the remainder of diethyl ether is removed by blowing dry air. Then the unit cell is placed between binding posts made of iron and nickel respectively. Obtained electrical power generator is connected to a power source.

### EXAMPLE 2

Making a unit cell of barium titanate doped with niobium.

The unit cell is made by means of the technique described in Example 1, werein instead of barium titanate barium titanate doped with niobium is used.

### EXAMPLE 3

The unit cell is made by means of the technique described in Example 1, werein instead of barium titanate barium titanate doped with lanthanum is used.

Table 1 shows the relationship between electric power (mW) and values of voltage (V) and electric current (mA) of one unit cell at external load of 1000 Ohm from ferroelectric materials semiconductors relatively to reference sample by prototype made of barium titanate.

We studied the duration of work of each of the ferroelectric-semiconductor, which is part of a single unit cell. In the temperature range from −20 to +110 degrees Celsius each unit cell is continuously operated for more than 18000 hours.

TABLE 1

| | electric power | voltage | electric current |
|---|---|---|---|
| Ferroelectric material | (mW) | (V) | (mA) |
| barium titanate | 1.129 | 1.062 | 1.063 |
| barium titanate doped | 2.358 | 1.060 | 2.225 |
| with niobium (Nb) | | | |
| barium titanate doped | 2.111 | 1.061 | 1.990 |
| with lanthanum (La) | | | |

As it can be seen according to the table, in case of using ferroelectric semiconductors electrical power increases dramatically. When barium titanate doped with niobium (Nb) is used electrical power of the generator unit cell increases by 2,088 times relative to the prototype. When barium titanate doped with lanthanum (La) is used electrical power of the generator unit cell increases by 1,869 times with respect to the prototype. The claimed power generator has a significant advantage over the prototype according to its practical application.

### SUMMARY OF INVENTION

### Electrical Power Generator

The invention is related to electrical engineering and can be used to generate electricity. Electrical power generator made up of a case with a package of conduction plates of both signs that are separated by a layer of ferroelectric, wherein all layers in the package bear tightly against each other and the metal plates are made of dissimilar conductors with significant difference of the free electrons concentration i.e. of two different metals, for example, antimony-bismuth, iron-nickel, titanium-aluminum, and various alloys, such as chromel-alumel, chromel-Copel, or a metal-alloy combination, such as iron-Copel, antimony-alumel, chromel-bismuth, herewith a package of plates includes at least one elementary cell which consists of one layer of a ferroelectric material and two dissimilar conduction plates which are placed in the following order: a conduction plate-a ferroelectric material-a conduction plate different from the first one, and if the package contains more than one unit cell then they are connected to the a source of electrical energy in series or in parallel, or in combination—some unit cells are connected in series, and some are connected in parallel, herewith ferroelectric semiconductors are used as ferroelectric material, such as sodium nitrite, semiconductor ceramics based on barium titanate, lithium niobate, potassium niobate, lead titanate, etc. When barium titanate doped with niobium (Nb) is used electrical power of the generator unit cell increases by 2,088 times relative to the prototype. When barium titanate doped with lanthanum (La) is used electrical power of the generator unit cell increases by 1,869 times.

1. Electrical power generator made up of a case with a package of conduction plates of both signs that are separated by a layer of ferroelectric, wherein all layers in the package bear tightly against each other and the metal plates are made of dissimilar conductors with significant difference of the free electrons concentration i.e. of two different metals, for example, antimony-bismuth, iron-nickel, titanium-aluminum, and various alloys, such as chromel-alumel, chromel-Copel, or a metal-alloy combination, such as iron-Copel, antimony-alumel, chromel-bismuth, herewith a package of plates includes at least one elementary cell which consists of one layer of a ferroelectric material and two dissimilar conduction plates which are placed in the following order: a conduction plate-a ferroelectric material-a conduction plate different from the first one, and if the package contains more than one unit cell then they are connected to the a source of electrical energy in series or in parallel, or in combination—some unit cells are connected in series, and some are connected in parallel. The main difference of the claimed generator is the usage of ferroelectric semiconductors as ferroelectric material, such as sodium nitrite, semiconductor ceramics based on barium titanate, lithium niobate, potassium niobate, lead titanate, etc.
